(19) United States
(12) Patent Application Publication
(10) Pub. No.: US 2012/0305465 A1
(43) Pub. Date: Dec. 6, 2012

(54) SIEVING DEVICE

(75) Inventor: Dietrich EICHLER, Koenigstein (DE)

(73) Assignee: ROEHREN-UND PUMPENWERK BAUER GES.M.B.H., Voitsberg (AT)

(21) Appl. No.: 13/483,282

(22) Filed: May 30, 2012

(30) Foreign Application Priority Data
Jun. 1, 2011 (DE) 10 2011 103 160.3

(51) Int. Cl. B01D 35/20

(52) U.S. Cl. 210/242.1

(57) ABSTRACT

The present invention relates to a sieving device 10 for separating liquid constituents from a slurry 9 containing liquid and solid constituents, the sieving device being configured to be floatingly inserted into the slurry 9, comprising: a tank for collecting the separated liquid constituents, at least one sieve 3 for separating the liquid constituents, the sieve forming at least part of the wall of the tank, at least one vibrator 5 fastened by means of a vibration decoupling device 6 to the sieving device 10, and at least one plunger 4 which is connected with one end to the vibrator 5 and with the other end directly to the sieve 3 so as to directly cause the sieve to vibrate.

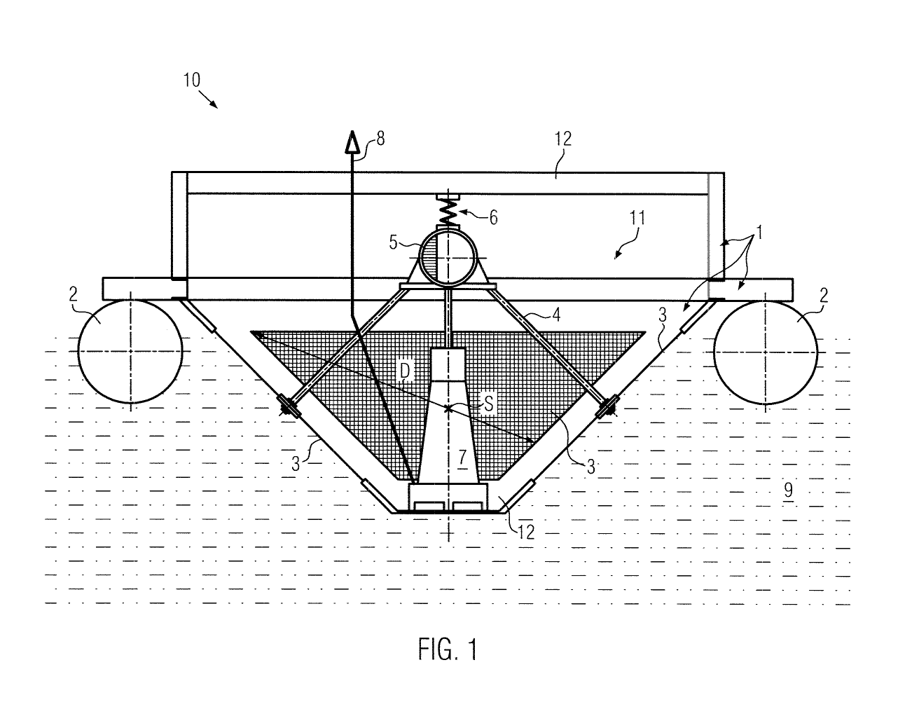

The present invention refers to a sieving device for separating liquid constituents from a slurry which contains liquid and solid constituents. The sieving device is here configured to be floatingly inserted into the slurry.

DE 10 2009 036 536 A1 shows a floating filter device of the prior art. A tank having a wall which consists at least in part of a sieve or a filter is here inserted into the slurry. The separated liquid collects in the interior of the tank and is pumped off. To prevent clogging of the sieves or the filters, the complete filter device, including the frame and the floats, is made to vibrate in the prior art. It is here disadvantageous that a relatively great amount of energy has to be applied for the vibration of the whole device and that the complete prior-art device is burdened by the oscillation or vibration.

It is the object of the present invention to provide a sieving device to be floatingly inserted into a slurry, which device enables an efficient separation of the liquid constituents from the slurry.

This object is achieved by the features of the independent claim. The dependent claims refer to advantageous developments of the invention.

Hence, the object is achieved by a sieving device for separating liquid constituents from a slurry containing liquid and solid constituents, the device being configured to be floatingly inserted into the slurry, comprising a tank for the entry and collection of the separated liquid constituents, at least one sieve for separating the liquid constituents, the sieve forming at least part of the wall of the tank, at least one vibrator fastened by means of a vibration decoupling device to the sieving device, and at least one plunger which is connected with one end to the vibrator and with the other end directly to the sieve so as to directly cause the sieve to vibrate.

The term sieve as used encompasses both fine sieves and coarse sieves, e.g. perforated sieves or grid sieves, and also filters. The sieves can be arranged in any position between a horizontal and a vertical position. Furthermore, the combination of a coarse sieve or a fine sieve with a filter material is encompassed by the term sieve. The term slurry encompasses particularly communal or agricultural waste waters and pulp as occurs in paper production. The term “wall” refers to the side walls and to the bottom of the tank.

According to the invention the vibrator is fastened to the sieving device in a vibration-decoupled manner. The vibration decoupling device used for this purpose avoids as much as possible any vibration transmission from the vibrator to the suspension point of the vibrator at the sieving device. The vibrating or oscillating movement of the vibrator is thereby just transmitted via the plunger. The plunger, in turn, is directly connected to the sieve, so that the sieve is caused to vibrate and clogging of the sieve is consequently avoided.

It is intended in a particularly preferred configuration that the sieving device comprises a frame for accommodating the at least one sieve. The frame is particularly made rigid. The one sieve or the plurality of sieves that are arranged in the frame form the tank. The separated liquid constituents collect particularly in the lower portion of said tank.

It is intended in a particularly preferred configuration that the vibrator is fastened by means of the vibration decoupling device to the frame. To be more specific, the vibrator is suspended without oscillation by means of the vibration decoupling device from the frame.

Furthermore, it is of advantage that the sieve is configured and/or fastened in such a manner that it does not transmit or only transmits a small vibration to the frame. To this end there exist two preferred options that can be used either in combination or individually: On the one hand it is preferably intended that the at least one sieve is fastened via a further vibration decoupling device in the frame so as to prevent any transmission of the vibration from the sieve to the frame. Rubber buffers between the sieve and the frame are here particularly appropriate. Alternatively or in addition, it is preferably intended that the sieve is so unstable in its structure that the vibration introduced into the sieve is dampened towards the rim of the sieve so as to prevent transmission of the vibration from the sieve to the frame.

To be more specific, the sieve is configured as a perforated metal sheet or as a wire mesh. In addition, filter materials, such as a felt, may also be provided on the sieve. It is intended in a particularly preferred manner that a ratio of the metal-sheet thickness or wire thickness to the greatest diameter of the sieve is smaller than or equal to 1/100, particularly smaller than or equal to 5/1000. The greatest diameter of the sieve is here measured through the center of gravity, normally the geometric center of gravity, of the sieve.

Furthermore, it is of advantage that the plunger is operative in the area of the center of gravity of the sieve. It is of special advantage, particularly for avoiding transmission of the vibration from the sieve to the frame, that the plunger is operative in the area of the center of gravity of the sieve. As a rule, the geometric center of gravity of the sieve must here be chosen. In the case of a bent sieve the geometric center of gravity of the sieve may be located outside the sieve. In this case, the plunger acts on the sieve in the area of the vertical projection of the center of gravity. The “area of the center of gravity” in which the plunger is operative has to be understood in a relatively wide sense because it is here of prime importance that the vibration of the sieve on the rim of the sieve is approximately zero so that no vibration is transmitted from the sieve to the frame. To be more specific, the point of action of the plunger deviates from the center of gravity of the sieve by not more than half of the greatest diameter of the sieve, particularly by not more than one quarter of the greatest diameter of the sieve.

Furthermore, it is of advantage that the vibration decoupling device between vibrator and sieving device and/or the further vibration decoupling device between sieve and frame comprises a spring and/or an elastic, particularly rubber-elastic, element. The vibration decoupling device between vibrator and sieving device is particularly preferably configured as a spring. The vibrator is then suspended by means of the spring from the sieving device, particularly from a bracket, as part of the frame, above the tank.

In a particularly preferred configuration the sieving device according to the invention comprises a plurality of sieves. At least two, particularly all, sieves are here driven with a joint vibrator. Each sieve is here particularly connected with its own plunger to the vibrator.

Furthermore, a pump is preferably provided in the interior of the tank for discharging the separated liquid constituents.

Moreover, floats are preferably mounted on the sieving device so as to impart buoyancy to the sieving device in the slurry. As an alternative or in addition to the floats, the sieving device according to the invention may also be suspended to thereby float on the surface of the slurry.

The vibrator is particularly configured as a rotating eccentric device, with the plungers being fastened to an eccentric output shaft of the vibrator.

The invention will now be explained in more detail with reference to the accompanying drawing. The sole FIGURE shows a sieving device of the invention according to embodiment.

The sole FIGURE shows the sieving device 10 for separating liquid constituents from a slurry 9 containing liquid and solid constituents. The two floats 2 impart buoyancy to the sieving device 10 in the slurry 9.

The sieving device 10 comprises a tank 11. The walls of said tank 11 are inter alia formed by four sieves 3. The individual sieves 3 are made trapezoidal and are fastened in a frame 1. The upper edge of the tank 11 is held by the floats 2 above the liquid level of the slurry 9. As a consequence, liquid constituents of the slurry 9 can only flow through the sieves 3 into the interior of the tank 11. A pump sump 12 is formed on the lower end of the tank 11. A submersible pump 7 is accommodated in said pump sump 12. The pump 7 pumps the collected liquid via the outlet 8 to the outside.

To avoid clogging of the sieves 3 by the solid constituents of the slurry 9, the sieves 3 are caused to vibrate. A vibrator 5 is provided for this purpose. The vibrator 5 is connected by means of a vibration decoupling device 6 to the sieving device. To this end the frame 1 comprises a bracket 12 which extends over the tank 11. The vibrator 5 is suspended from said bracket 12 by means of the vibration decoupling device 6. The vibration decoupling device 6 is here configured as a spring. Said vibration decoupling device 6 prevents about every transmission of vibration or oscillation from the vibrator 5 to the frame 1.

Furthermore, a vibrating output of the vibrator 5 is directly connected via a plunger 4 to one of the sieves 3. The respective sieves 3 are directly caused to vibrate via the plungers 4. As a consequence, the vibration or oscillation is not directly introduced onto the frame 1. The plungers 4 are here operative approximately at the geometric center of gravity of the sieves 3. As a consequence, the point of action of the plungers 4 has the greatest possible distance from the rim of the sieves 3. The oscillation introduced into the sieves 3 diminishes more or less completely towards the rim of the sieves 3, so that no vibration or oscillation is transmitted from the sieves 3 to the frame 1.

The maximum diameter D of the sieves is measured through the geometric center of gravity S of the sieves 3.

Thanks to the configuration of the sieving device according to the invention only the sieves 3 are subjected to the vibration. To even further reduce a transmission of the vibration or oscillation from the sieves 3 to the frame 1, the sieves 3 are configured on the one hand to be so unstable that the oscillation towards the rim of the sieves 3 is reduced as much as possible. Moreover, a further vibration decoupling device, which is particularly configured as a rubber buffer, may be positioned between the rim of the sieves 3 and the frame 1.

1-9. (canceled)

10. A sieving device for separating liquid constituents from a slurry containing liquid and solid constituents, which is configured to be floatingly inserted into the slurry, comprising:
a tank for the entry and collection of the separated liquid constituents,
at least one sieve for separating the liquid constituents, the sieve forming at least part of the wall of the tank,
at least one vibrator fastened by means of a vibration decoupling device to the sieving device, and
at least one plunger which is connected with one end to the vibrator and with the other end directly to the sieve so as to directly cause the sieve to vibrate,
wherein the sieving device comprises a frame for accommodating the at least one sieve, and
the vibrator is suspended by means of the vibration decoupling device (6) from the frame.

11. The sieving device according to claim 10, characterized in that the at least one sieve is fastened via a further vibration decoupling device in the frame to prevent transmission of the vibration from the sieve to the frame.

12. The sieving device according to claim 10, characterized in that the sieve is so unstable in its structure that the vibration introduced into the sieve is dampened towards the rim of the sieve to prevent transmission of the vibration from the sieve to the frame.

13. The sieving device according to claim 10, characterized in that the at least one sieve comprises a perforated metal sheet or wire mesh, wherein particularly a ratio of the metal-sheet thickness or wire thickness to the greatest diameter of the sieve is smaller than or equal to 1/100, particularly smaller than or equal to 7/1000, particularly smaller than or equal to 5/1000.

14. The sieving device according to claim 10, characterized in that the plunger is operative in the area of the center of gravity of the sieve.

15. The sieving device according to claim 10, characterized in that the vibration decoupling device and/or the further vibration decoupling device comprises a spring and/or an elastic, particularly rubber-elastic, element.

16. The sieving device according to claim 10, characterized by a plurality of sieves, wherein at least two sieves can be caused to vibrate by means of a vibrator via a respective plunger.

17. The sieving device according to claim 10, characterized by a pump in the interior of the tank for discharging the separated liquid constituents.

18. The sieving device according to claim 10, characterized by at least one float mounted on the sieving device to impart buoyancy to the sieving device in the slurry.
